(19) United States
(12) Patent Application Publication
(10) Pub. No.: US 2004/0137331 A1
(43) Pub. Date: Jul. 15, 2004

(54) Separator for lithium battery and lithium battery employing the same and method of manufacture thereof

(76) Inventors: Su-Jin Han, Cheonan-city (KR); Chang-Seob Kim, Cheonan-city (KR); Yoon-Tai Kwak, Cheonan-city (KR); Ju-Hyung Kim, Cheonan-city (KR); Soo-Youn Maeng, Incheon-city (KR); Jun-Won Kang, Cheonan-city (KR)

Correspondence Address: Robert E. Bushnell, Suite 300, 1522 K Street, N.W., Washington, DC, 20005-1202, US

(21) Appl. No.: 10/746,181

(22) Filed: Dec. 29, 2003

(30) Foreign Application Priority Data
Dec. 27, 2002 (KR) 2002-85437

(51) Int. Cl. H01M 2/16

(52) U.S. Cl. 429/247; 429/254; 429/144

(57) ABSTRACT

A separator for a lithium battery having an elastic modulus of 2.0 kgf/mm² or less, and a lithium battery employing the separator and a method of manufacture thereof are provided.

### CLAIM OF PRIORITY

This application claims priority to an application entitled SEPARATOR FOR LITHIUM BATTERY AND LITHIUM BATTERY EMPLOYING THE SAME, filed in the Korean Intellectual Property Office on 27 Dec. 2002 and assigned Serial No. 2002-85437, the contents of which are hereby incorporated by reference.

### BACKGROUND OF THE INVENTION

### TECHNICAL FIELD

The present invention relates to a separator for a lithium battery and a lithium battery employing the same and a method of manufacturer thereof, and more particularly, to a separator for a lithium battery which can suppress deformation of an electrode assembly due to swelling occurring to an electrode plate during charging, and a lithium battery employing the same and a method of manufacture thereof.

### RELATED ART

In recent years, with the development of advanced electronic devices, small, lightweight electronic equipment have gained popularity, which has gradually increased the use of portable electronic devices. Accordingly, batteries having a high energy density and extended cycle life to be used as power supplies for such portable electronic devices have been increasingly demanded. Among these batteries, lithium batteries are under vigorous research.

A lithium battery, specifically, a lithium secondary battery, basically includes a positive electrode, a negative electrode and a separator interposed therebetween. When the positive electrode, the separator and the negative electrode are disposed in that order, the resulting stack is wound or multiple stacks are laminated, thereby forming an electrode assembly.

A lithium secondary battery is manufactured in various shapes according to the type of battery case used, and examples thereof include a cylindrical or rectangular case and a pouch type case.

In general, an electrode assembly employed in a rectangular lithium secondary battery is formed by stacking a positive electrode plate, a separator and negative electrode plate and winding the resulting stack in a jelly-roll configuration. The positive electrode plate has a positive electrode coated portion where a positive electrode active material is coated on a positive electrode current collector, and a positive electrode un-coated portion where a positive electrode active material is not coated on the positive electrode current collector. Likewise, the negative electrode plate also has a negative electrode coated portion where a negative electrode active material is coated on a negative electrode current collector, and a negative electrode un-coated portion where a negative electrode active material is not coated on a negative electrode current collector. An electrode tab is attached to each of the positive electrode un-coated portion and the negative electrode un-coated portion.

The separator interposed between the positive electrode plate and the negative electrode plate insulates the positive electrode plate and the negative electrode plate from each other, and allows active material ions to be exchanged therebetween, causing an electrochemical reaction.

In the lithium secondary battery employing the aforementioned electrode assembly, the electrode plates and/or the separator may swell due to impregnation of an electrolytic solution during charging. In such a case, the electrode assembly may experience structural deformation due to swelling deviations, resulting in a deterioration of battery performance.

U.S. Pat. No. 5,683,634 to Fujii et al., entitled PROCESS OF MAKING POROUS FILM OR SHEETS, issued on Nov. 4, 1997 relates to a porous film or sheet including a resin composition mainly of an ultra-high molecular weight polyethylene having a viscosity-average molecular weight of not less than 500,000, and having a thickness of 10 to 100 .mu.m, an air permeability of 20 to 2,000 sec/100 cc, a porosity of 15 to 80%, a pin puncture strength (per 25 .mu.m of film thickness) of not less than 120 g, a thermal-shut down temperature of 90.degree. to 150.degree. C. and a heat puncture temperature of not less than 160.degree. C., and a process for producing the same.

U.S. Patent Publication No. 2002/0122986 A1 to Labarge et al., entitled LITHIUM BATTERY WITH SEPARATOR STORED LITHIUM, issued on Sep. 5, 2002 relates to a lithium battery having a separator capable of storing excess lithium ions. As lithium ions are irreversibly adsorbed by the battery electrodes, they are replenished from the excess lithium stored in the separator material, thereby extending battery life. In an example of the present invention, molecular sieves, such as 13X molecular sieves, are used as the separator material. Molecular sieves are hydroscopic and therefore also react with moisture in the battery, thereby reducing cell impedance.

U.S. Patent Publication No. 2002/0160268 A1 to Yamaguchi et al., entitled POROUS FILM, PROCESS FOR PRODUCING THE SAME, AND USES THEREOF, issued on Oct. 31, 2002 relates to a porous film having high strength, homogeneous porous structure, and excellent affinity for electrolytic solutions and suitable for use as a separator for batteries and capacitors; a process for producing the film; and a battery and capacitor each employing the porous film as a separator. The porous film comprises a resin composition including from 70 to 99.9% by weight of an high molecular weight polyolefin resin and from 0.1 to 30% by weight of a polymer having a polyacrylate, polymethacrylate, poly (ethylene oxide), poly (propylene oxide), poly(ethylene propylene oxide), polyphosphazene, poly(vinyl ether) or polysiloxane structure as or in a main chain and having a chain oligo (alkylene oxide) structure in side chains. The porous film can be obtained by heating and kneading the high molecular weight polyolefin resin and the polymer in a solvent to thereby obtain a kneaded product, forming the kneaded product into a gel-state sheet, rolling and/or stretching the sheet, and then subjecting the sheet to a solvent-removing treatment.

U.S. Patent Publication No. 2003/0003368A1 to Lee et al., entitled POLYMER ELECTROLYTE, PREPARATION METHOD FOR THE SAME AND LITHIUM BATTERY USING THE SAME, issued on Jan. 2, 2003 relates to a polymer electrolyte which is formed by curing a composition prepared by mixing a polymer of compounds of polyethylene glycol di(meth)acrylates and/or multi-functional ethyleneoxides; one selected from a vinylacetate monomer, a (meth)acryalte monomer, and a mixture of a vinylacetate monomer and a (meth)acrylate monomer; and an electrolytic solution containing a lithium salt and an organic solvent.

U.S. Patent Publication No. 2003/0157411 A1 to Jung et al., entitled POLYMER ELECTROLYTE AND LITHIUM BATTERY EMPLOYING THE SAME, issued on Aug. 21, 2003 relates to a solid polymer electrolyte, a lithium battery employing the same, and methods of forming the electrolyte and the lithium battery. The polymer electrolyte includes polyester (meth)acrylate having a polyester polyol moiety having three or more hydroxide (—OH) groups, at least one hydroxde group being substituted by a (meth)acrylic ester group and at least one hydroxide group being substituted by a radical non-reactive group, or its polymer, a peroxide having 6 to 40 carbon atoms, and an electrolytic solution including a lithium salt and an organic solvent.

While the afore-cited references include features relating to the present invention, none of the references teach or suggest the present invention, namely, a separator for a lithium battery which can suppress deformation of an electrode assembly due to swelling occurring to an electrode plate during charging, and a lithium battery employing the same and a method of manufacturer thereof.

### SUMMARY OF THE INVENTION

To solve the above problems, the present invention provides a separator for a lithium battery in which deformation of an electrode assembly due to swelling of electrode plates and/or the separator, is suppressed, and a lithium battery employing the same and a method of manufacture thereof.

In one aspect of the present invention, there is provided a separator for a lithium battery, the separator having an elastic modulus of 2.0 kgf/mm² or less.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 consists of graphical representations of results of tensile strength tests performed on three separators

FIG. 2 consists of three example photographs of jelly-roll type electrode assemblies after charging lithium secondary batteries according to Examples 1 and 2 of the present invention and Comparative Example 1;

FIG. 3 consists of three example photographs of unrolled electrode assemblies after charging the lithium secondary batteries according to Examples 1 and 2 of the present invention and Comparative Example 1; and

FIG. 4 consists of two photographs of jelly-roll electrode assemblies after pressing and after charging, respectively.

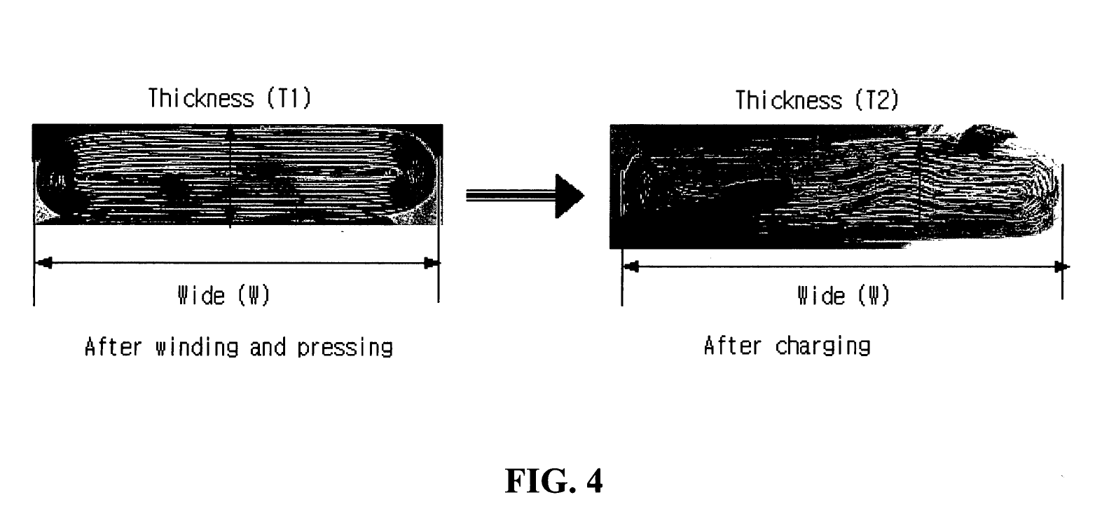

### DESCRIPTION OF THE PREFERRED EMBODIMENT

A separator according to the present invention preferably has an elastic modulus of 2.0 kgf/mm² or less, more preferably 0.1 to 2.0 kgf/mm². If the elastic modulus is greater than 2.0 kgf/mm², the separator cannot withstand extension of positive and negative electrode plates, unfavorably resulting in deformation of the positive and negative electrode plates.

The separator is made from polyethylene (PE), polypropylene(PP) or a combination thereof, and has a single-layered structure or a multi-layered structure of two or three layers. Specifically, it is preferable that the separator includes a PE single layer or a PP/PE/PP triple layer.

The principle of the present invention will now be described with reference to the accompanying drawings.

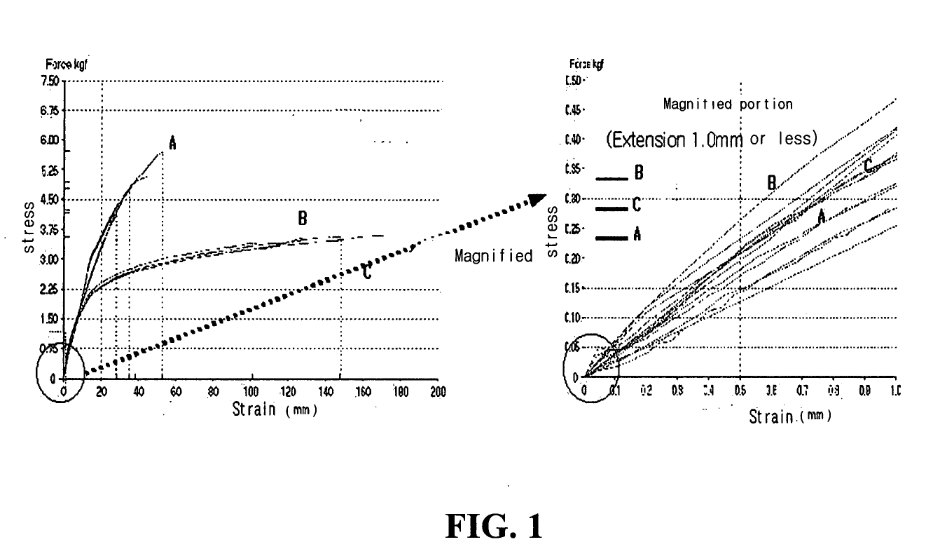

FIG. 1 shows results of tensile strength tests performed on separators A, B and C, which have elastic moduli of 0.2˜1.2 kgf/mm², 1.2˜2.0 kgf/mm², and 2.0˜4.0 kgf/mm², respectively.

Referring to the left graph of FIG. 1, the separator B has the highest elongation characteristic but has poor tensile strength. In contrast, the separators A and C have high tensile strength but have poor elongation characteristic.

In FIG. 1, the portion marked by a circle is an area where a strain due to a stress applied by swelling of the electrode plates during charging does not occur to the separators, but is an area where an elastic deformation behavior, that is, deformation being of 1.0 mm or less, is exhibited by the separators, as magnified in the right graph of FIG. 1. In order to minimize deformation of electrode plates, a separator must have a low elastic modulus in this area so that it can withstand the stress applied to the electrode plates.

An elastic modulus is a ratio of stress to strain. Viewed from the right graph of FIG. 1, the elastic modulus decreases in the order from the separator C to the separator B and to the separator A. Thus, the deformation suppressing effect is presumably highest in the separator A, which has the lowest elastic modulus.

Now, a method of preparing a lithium battery according to the present invention will be described.

First, a cathode and an anode are manufactured by the same method generally used in manufacturing a lithium battery. Here, a lithium metal composite oxide or a sulfur compound can be used as a cathode active material, and a lithium metal, a carbonaceous material or graphite can be used as an anode active material.

A separator having the elastic modulus, that is, 2.0 kgf/mm² or less, is interposed between the thus-prepared cathode and anode, followed by winding in a jelly-roll configuration, to form an electrode assembly.

Thereafter, the electrode assembly is accommodated in a battery case. Then, an electrolytic solution is injected into the battery case, thereby completing a lithium secondary battery.

The electrolytic solution of the present invention consists of a lithium salt and an organic solvent. As the lithium salt, any material that is widely known in the art to which the present invention pertains can be used without particular restriction, and the content of the lithium salt is in the range typically used for the manufacture of lithium batteries. Examples of the lithium salt useful in the present invention include LiPF₆, LiBF₄, LiAsF₆, LiClO₄, CF₃SO₃Li, LiC(CF₃SO₂)₃, LiN(C₂F₅SO₂)₂, LiN(CF₃SO₂)₂, LiCoO₂, LiNiO₂, LiMnO₂, LiMn₂O₄ and the like. As the organic solvent, cyclic carbonates such as ethylene carbonate or propylene carbonate, linear carbonates such as dimethyl carbonate, diethyl carbonate or dimethylethyl carbonate (EMC), fluorobenzene (FB), vinyl sulfone (VS), and the like, are preferably used. In the electrolytic solution, the organic solvent is added such that the concentration of lithium salt is in a range of 0.5-1.5 M.

The present invention will now be described through the following examples. However, the invention is understood to not be limited thereto.

### <EXAMPLE 1>

94 g of LiCoO₂, 3 g of Super P conductive carbon available from MMM Ltd., 3 g of polyvinylidenefluoride (PVDF) were dissolved in 500 g ofN-methylpyrrolidone (NMP) to produce a cathode active material composition. Then, an aluminum foil was coated with the cathode active material composition and dried to prepare a cathode.

89.8 g of mezocarbon fiber (MCF available from Petoca, Ltd.), 0.2 g of oxalic acid and 10 g of PVDF were dissolved in 500 g of NMP to produce an anode active material composition. Then, a copper (Cu) foil was coated with the anode active material composition and dried to prepare an anode.

A polyethylene separator having an elastic modulus of 0.1-1.2 kgf/mm² was interposed between the cathode and the anode, and the resultant structure was wound in a jelly-roll configuration, forming a jelly-roll type electrode assembly was pressed.

Then, the resultant electrode assembly was accommodated in a battery case, followed by injecting an electrolytic solution having ethylene carbonate, ethylmethyl carbonate, dimethyl carbonate and fluorobenzene mixed in a weight ratio of 3:5:1:1 and 0.55% vinyl sulfone (VS) as an additive, thereby completing a lithium secondary battery.

### <EXAMPLE 2>

A lithium secondary battery was prepared in the same manner as in Example 1, except that a polyethylene separator having an elastic modulus of 1.2-2.0 kgf/? was used.

### <Comparative Example 1>

A lithium secondary battery was prepared in the same manner as in Example 1, except that a polyethylene separator having an elastic modulus of 2.0-4.0 kgf/mm² was used.

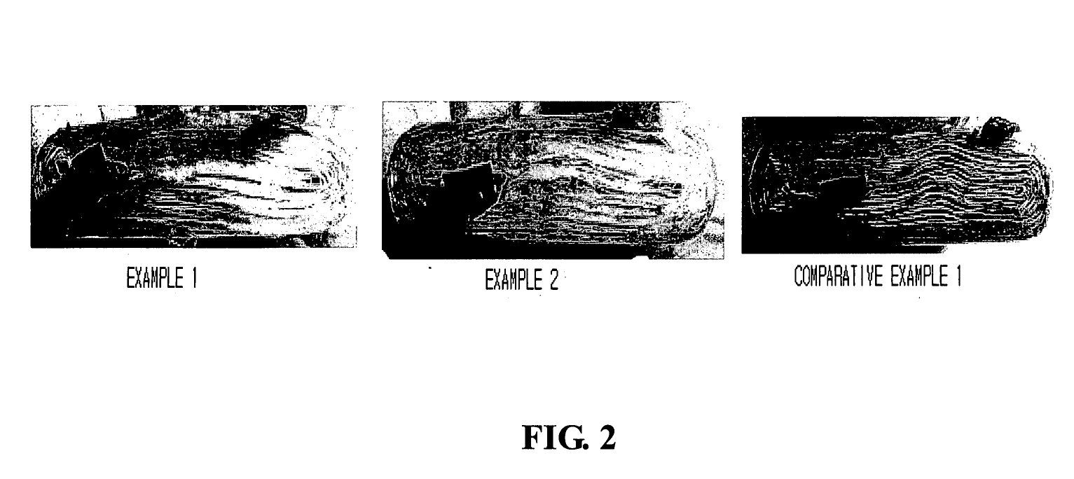

Charging was performed on the lithium secondary batteries prepared in Examples 1 and 2 and Comparative Example 1, and then shapes of the jelly-roll type electrode assemblies after winding and pressing were observed with the naked eye. The observation results are shown in FIG. 2. Here, the lithium batteries were charged under 0.2 C and 4.2 V for 20 minutes, and then charging was continued under 0.8 C and 4.2 V for 160 minutes.

Referring to FIG. 2, the jelly-roll type electrode assemblies according to Examples 1 and 2 were less deformed than the jelly-roll type electrode assembly according to Comparative Example 1, confirming that deformation of a jelly-roll type electrode assembly occurring during charging could be efficiently suppressed when the elastic modulus is in a range of about 0.1 to 2.0 kgf/mm² and the elastic modulus is relatively low.

Also, after the lithium secondary batteries prepared in Examples 1 and 2 and Comparative Example 1 were charged, extents of swelling of jelly-roll type electrode assemblies employed in the respective lithium batteries were examined.

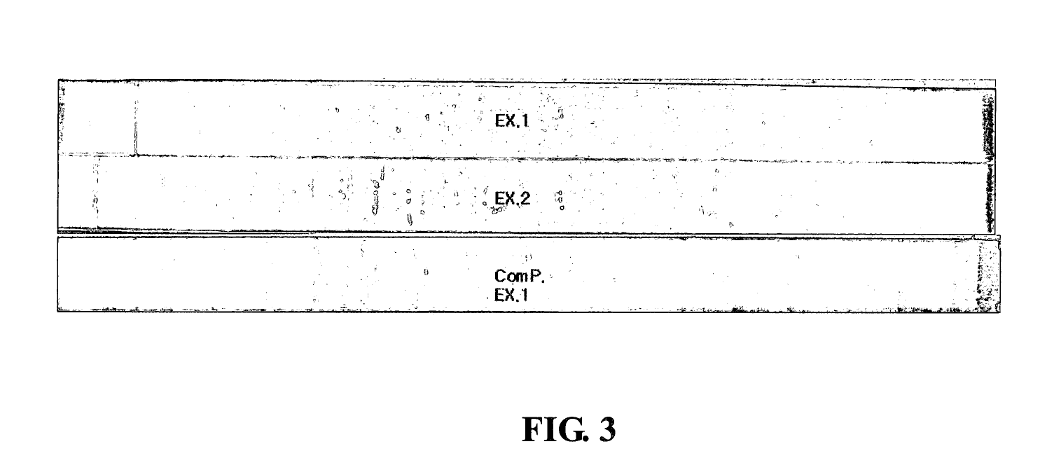

FIG. 3 illustrates photographs of unrolled electrode assemblies employed in the lithium secondary batteries according to Examples 1 and 2 of the present invention and Comparative Example 1, in which the photographs indicated by Nos. 1, 2 and 3 represent anodes of the unrolled electrode assemblies in Examples 1 and 2 of the present invention and Comparative Example 1, respectively.

Referring to FIG. 3, the frequency of occurrence of and the degree of deformation as well as the quantity of precipitates produced due to deformation were less in the anodes of Examples 1 and 2 than in the anode of Comparative Example 1.

To evaluate degrees of swelling in the electrode assemblies in Examples 1 and 2 of the present invention and Comparative Example 1, the thickness of each pressed jelly-roll type electrode assembly was measured before and after charging, as denoted by T1, T2, and the results thereof are shown in Table 1.

TABLE 1

| | Degree of swelling *(mm) | Thickness (mm) |
|---|---|---|
| Example 1 | 0.71 | 7.75 |
| Example 2 | 0.80 | 7.85 |
| Comparative Example 1 | 0.86 | 7.90 |

In Table 1, the degree of swelling equals a difference between a thickness (T1) of a jelly-roll type electrode assembly before charging and a thickness (T2) of the jelly-roll type electrode assembly after charging.

As understood from Table 1, the electrode assemblies prepared in Examples 1 and 2 of the present invention and Comparative Example 1 exhibited lower degrees of swelling and less deformation than the electrode assembly prepared in Comparative Example 1.

Use of the separator according to the present invention suppresses deformation of an electrode assembly due to swelling of electrode plates during charging, thereby effectively preventing an increase in the thickness of the electrode assembly after charging. Also, the quantity of precipitates, i.e., metallic lithium, produced due to excessive intercalation of lithium ions at deformation portions of the electrode assembly, can be minimized.

What is claimed is:

1. A separator for a lithium battery, the separator having an elastic modulus of 2.0 kgf/mm² or less.

2. The separator of claim 1, wherein the elastic modulus is in a range of 0.1 to 2.0 kgf/mm².

3. The separator of claim 1, the separator comprising at least one of polyethylene, polypropylene or a compound thereof.

4. The separator of claim 3, the separator comprising at least one of a polyethylene single layer or a polypropylene/polyethylene/polypropylene triple layer.

5. A lithium battery comprising the separator of claim 1.

6. A lithium battery comprising the separator of claim 2.

7. A lithium battery comprising the separator of claim 3.

8. A lithium battery comprising the separator of claim 4.

9. A method of manufacturing a separator for a lithium battery, the method comprising forming the separator to have an elastic modulus of 2.0 kgf/mm² or less.

10. The method of claim 9, wherein the elastic modulus of the separator is in a range of 0.1 to 2.0 kgf/mm².

11. The method of claim 9, the method comprising forming the separator to comprise at least one of polyethylene, polypropylene or a compound thereof.

12. The method of claim 11, the method comprising forming the separator to comprise at least one of a polyethylene single layer or a polypropylene/polyethylene/polypropylene triple layer.

13. A method of manufacturing a lithium battery, the method comprising forming a separator to have an elastic modulus of 2.0 kgf/mm² or less.

14. The method of claim 13, wherein the elastic modulus of the separator is in a range of 0.1 to 2.0 kgf/mm².

15. The method of claim 13, the method comprising forming the separator to comprise at least one of polyethylene, polypropylene or a compound thereof.

16. The method of claim 15, the method comprising forming the separator to comprise at least one of a polyethylene single layer or a polypropylene/polyethylene/polypropylene triple layer.
